(19) United States
(12) Patent Application Publication
(10) Pub. No.: US 2005/0061741 A1
(43) Pub. Date: Mar. 24, 2005

(54) Method for treating reverse osmosis membranes with chlorine dioxide

(76) Inventors: Eric L. Mainz, Goddard, KS (US); Gregory D. Simpson, Seabrook, TX (US)

Correspondence Address: ARMSTRONG, KRATZ, QUINTOS,;HANSON & BROOKS, LLP, Suite 220, 502 Washington Avenue, Towson, MD, 21204, US

(21) Appl. No.: 10/830,549

(22) Filed: Apr. 23, 2004

Related U.S. Application Data
(60) Provisional application No. 60/505,361, filed on Sep. 23, 2003.

(51) Int. Cl. B01D 61/02

(52) U.S. Cl. 210/639; 210/749; 210/650; 210/206; 210/96.2

(57) ABSTRACT

Disclosed is a method for preventing osmotic membrane fouling comprising treating reverse osmotic feed water and membranes with chlorine dioxide at an extremely low concentration, e.g., as low as one part per billion in the feed water. The effective range may be in the range of 1-900 parts per billion. Also disclosed is a membrane separation system in which fouling is prevented using ultraviolet, pH acid adjustment or an electrochemical generator to produce the chlorine dioxide.

### RELATED APPLICATIONS

This application is related to provisional patent application Ser. No. 60/505,361, filed Sep. 23, 2003.

### BACKGROUND OF THE INVENTION

Membrane systems are widely used for a host of filtration applications. Depending on specific attributes and operating conditions, membranes can selectively separate components over a very wide range of particle sizes and molecular weights. The range of size exclusion available with membrane systems grows progressively smaller with microfiltration, ultrafiltration, nanofiltration and reverse osmosis. Membrane fouling can occur in nearly all membrane filtration systems. The problems caused by fouling are most severe with reverse osmosis (RO) systems. Many variables affect fouling. Included are feed water characteristics, pretreatment methods and system operation. The degree and frequency of fouling varies widely from one membrane system to another. Fouling to the point of cleaning being required can occur as limited as only once per year or as frequently as every day.

Foulants can be classified into four main categories; dissolved solids, suspended solids, biological, and non-biological organics. Biological fouling continues to be a major unresolved problem for membranes and systems. The present invention describes treatment chemicals and process for control of biological fouling of membranes filtration systems including RO (reverse osmosis) membranes and RO systems. Biofouling remains a significant problems because the most common RO membrane types in use today are attacked and degraded by chlorine and according to public literature, other oxidizing biocides. Chlorine is commonly used as a feed water biocide. However, it must be removed from the feed water prior to entering the RO system. Without chlorine or other biocides present, micororganisms colonize and form a biofilm in the RO system. Ultimately the RO membranes have to be removed from service and cleaned. Thus the biofilm causes a reduction in membrane performance and membrane damage leading to higher maintenance and system operating costs.

Objects of the Invention

A main object of the invention is to efficiently treat a membrane separation system to control biofilm formation.

Another object of the invention is produce a membrane biofilm control system which employs extremely low levels of chlorine dioxide.

A significant object of the invention is to produce a membrane system which controls biofilm and yet does not adversely affect the osmosis membrane.

### SUMMARY OF THE INVENTION

The object of the invention is to provide a novel method and composition for keeping clean membranes clean and minimizing the formation of biofilm in the membrane systems including on the surface of the membranes. It has been discovered that biofilm can be prevented from depositing and growing on membranes by dosing the feed water with very low concentrations of chlorine dioxide. The biofilm is controlled with no measurable damage to the membranes. Previous studies where chlorine dioxide has been used to treat RO membrane system feed water have indicated damage to the membranes leading to increased salt passage.

The herein disclosed invention contemplates using very small amounts (subparts per million) of chlorine dioxide in RO membrane systems. Amounts of chlorine dioxide substantially in the range of 1 to 900 parts per billion would be operative for preventing biofilm growth. Preferred levels of chlorine dioxide substantially in the range of 500 parts per billion and less as well as 100 parts per billion or less have been discovered to be effective in preventing biofilm growth. The treatment is effective over the wide pH range of 2 to 10. Surprisingly, no damage to the RO membranes was observed.

### DESCRIPTION

Membrane filtration systems including reverse osmosis (RO) systems are plagued by the growth and buildup of biofilm. Biofilm growth occurs on the surface of separation membranes, pressure vessels and piping upstream of the membrane(s). Prevention of biofilm buildup or the killing of biofilm already present can be accomplished by the treatment of the feed water with chlorine dioxide. The improvement consists of dosing the feed water with very low levels of chlorine dioxide on a continuous or intermittent basis. Another embodiment is to treat the feed water with sodium chlorite and then converting the chlorite to chlorine dioxide by passing the feed water over one or more ultraviolet lamps or by lowering the pH to convert chlorite to chlorine dioxide. The feed water containing subpart per million levels of chlorine dioxide is then fed to the membrane (such as RO) system.

Exemplary of the membranes used in this invention are those of Rak (U.S. Pat. No. 4,606,943), Sundet (U.S. Pat. No. 4,520,044), Cadotte (U.S. Pat. No. 4,277,344 and Larson et al (U.S. Pat. No. 3,933,561).

### DETAILED DESCRIPTION OF THE INVENTION

The invention is directed to the use of chlorine dioxide for minimizing and controlling biofouling of membrane separation systems.

Chlorine dioxide is commercially available by generation from sodium chlorite or sodium chlorate at the point of use. For small-scale applications, it is typical to generate the chlorine dioxide from sodium chlorite. U.S. Pat. Nos. 4,247,531; 4,547,381; 6,451,253; 6,171,558 and many others describe various methods for producing chlorine dioxide from sodium chlorite. The herein disclosed invention includes a novel process for the generation of minute amounts of chlorine dioxide in the feed water of the membrane separation system. Another innovation is the treatment of the membrane separation system such as an RO system and other membrane(s) with subpart per million levels of chlorine dioxide. It has been discovered that treatment of clean RO membranes with chlorine dioxide at a concentration of 1 to 500 parts per billion in the feed water is effective in preventing the formation of biofilm on an RO membrane. Treatment under these conditions resulted in no damage to the RO membrane. This is contrary to results published by Glater et al, American Chemical Society (1981) titled: The Effects of Halogens on the Performance and Durability of Reverse-Osmosis Membranes. Glater et al tested chlorine dioxide concentrations of 3 to 30 parts per million. Adams, Desalination, 78 (1990) pages 439-453, titled: The Effects of Chlorine Dioxide on Reverse Osmosis Membranes, conducted 6-month compatibility tests using a feed water chlorine dioxide concentration of 1000 parts per billion and recorded measurable damage to the RO membranes.

The examples below clearly demonstrate that very low levels of chlorine dioxide, less than 500 parts per billion in the feed water, provide biofilm control. Salt passage did not increase during the tests, which is a clear indicator of no membrane damage from the chlorine dioxide. The chlorine dioxide can be generated in a number of ways to produce a novel system for treating RO membranes at low dosages. A novel method is to treat a portion of the feed water, to which low levels of a chlorite salt, such as, sodium chlorite have been added, and to treat the chlorite with ultraviolet energy to induce formation of chlorine dioxide from the chlorite ion. Another novel method would be dosing the feed water with a solution containing a complex of sodium chlorite and chlorine dioxide. The chlorine dioxide is released from the complex upon dilution in the feed water. A third novel method is to dose a portion of the feed water to the RO system with sodium chlorite followed by pH adjustment such as by addition of mineral or other acid to cause conversion of some or all of the chlorite to chlorine dioxide.

Another novel aspect of the invention is the method for controlling the dosing of chlorine dioxide at the low levels of the invention. It has been discovered that a potentiostatic analyzer is capable of measuring and controlling the chlorine dioxide concentration in the feed water at the 5 to 500 parts per billion level. Other analyzers were not sensitive enough at this low concentration and hence unable to control the chlorine dioxide dosing to the feed water.

One embodiment of the invention comprises a system composed of a solution of chlorine dioxide, a chlorine dioxide feed pump set up to deliver solution to the RO system feed water supply, and a chlorine dioxide analyzer monitoring the feed water after the chlorine dioxide feed point which controls the chlorine dioxide feed pump. The chlorine dioxide feed concentration and/or the feed rate is adjusted to allow for steady control of the chlorine dioxide concentration in the feed water.

A second embodiment of the invention comprises a system composed of a solution of sodium chlorite and feed tank and pump, an acid solution, feed tank and pump, a pH monitor and controller which monitors the feed water (or portion thereof), and a chlorine dioxide analyzer monitoring the feed water after the sodium chlorite and acid feed point(s). The system is designed such that the addition of sodium chlorite and acid are controlled to give the desired concentration of chlorine dioxide in the feed water to the RO system.

A third embodiment of the invention comprises a system composed of a solution of sodium chlorite and a means for adding sodium chlorite to the RO feed water, adjusting the pH of the feed water if desired, exposing the feed water containing sodium chlorite to ultra violet light, measuring the subsequent concentration of chlorine dioxide with an analyzer which controls the addition of sodium chlorite to the feed water to maintain a set chlorine dioxide concentration in the concentration range of 1 to 900 parts per billion.

A fourth embodiment of the invention comprises a system composed of an electrochemical chlorine dioxide generator and feed pump for dosing chlorine dioxide to the RO feed water, measuring the subsequent concentration of chlorine dioxide in the feed water with an analyzer which controls the operation of the electrochemical generation and chlorine dioxide dosing systems. The system is operated to maintain a feed water chlorine dioxide concentration of at the desired level of 1 to 900 parts per billion

Operating Procedure for Reverse Osmosis Test Runs

Dow Filmtec FT-30™ membranes were fitted to a dual cell, flat plate RO test stand supplied by Osmonics Corporation. The flat plate design had an exposed membrane surface 4 inches in diameter. The 80 liters of feed water consisting of dechlorinated or deionized water containing 1000 parts per million sodium chloride were charged to the supply tank. The biocide type and concentration selected for a specific test run were added to the feed tank in either a batch or semi-continuous mode. A recirculation system was attached to the flat plates, which supplied the feed water to the cells at a pressure of 160 PSIG. The system was designed so the rejected water and the permeate water from both cells were sent back to the feed tank. A chiller was attached to the cooling coil submerged in the feed tank to maintain the temperature near 25 degrees centigrade. Only about 1 percent of the feed water was produced as permeate. The system was treated with a solution containing about 30 parts per million of chlorine dioxide prior to installation of the test membranes. A standard test consisted of a test run of 120 hours or more duration.

The following procedure was followed to test various solutions with the apparatus. The performance of the membrane samples in ability to remove sodium chloride from the feed solution and lack of flow reduction (production rate) was the measure of how well a treatment chemical protected the membrane from fouling, while not damaging the membrane itself.

System Sterilization

1. Sterilize the system as follows. Fill the tank to the top with tap water and add sufficient chemical to sterilize the system. ClO₂ at about 50 to 100-ppm was used for this series of tests. Circulate sterilization solution for 10-15 minutes.
2. Rinse the system several times with tap water. Only fill the tank as high as needed to allow the system pump to run. Run the pump several minutes. Drain the tank between rinses. Drain the tank and rinse the system 3-4 times, with de-ionized water. Once drained the system is ready for re-use.
   Membrane Performance Test Procedure
1. Fill the tank with 80 liters of de-ionized water. Ice can be added to maintain the tank temperature close to 25° C. if the ice is also from a de-ionized source.
2. Turn on the RO system pump. Adjustments are not critical at this point, but generally flow through all the lines is desired. Without membranes the pressure should be low and set for less than 40 psig.
3. Turn on the constant temperature bath and chiller.
4. Add sodium chloride (NaCl) to increase the total dissolved solids (TDS) by 1000. For this testing 80 grams of food grade NaCl was used.
5. Add treatment chemical according to the test to be run.
6. Adjust the pH according to the test to be run.
7. Turn off the RO system pump and install membranes.
   7.1. Cut two membrane squares. Cut the corner from one to mark it differently from the other.
   7.2. Open the cells and place the membranes face up on the bottom half of the cell. The two plastic screens are placed under the membrane with the heavy one on the bottom (either side up) and the mesh screen next. The O-ring should be placed in the groove in the top half of the cell.
   7.3. Lay the membrane onto the plastic screen and flush the surface with methanol (CH₃OH) to wet and sanitize the surface. Be certain that the membrane overlaps the circular area of the cell so that the O-ring will seal on the membrane surface.
   7.4. Place the top half of the cell over the bottom, install the stainless steel washers and wing nuts, and tighten the nuts finger tight.
8. Make certain the pressure bypass valve is fully open to prevent a sudden pressure surge from causing possible damage to the membranes. Turn on the RO system pump.
9. Adjust the bypass valve to set the desired system pressure.
10. Adjust the concentrate bypass valves (one on each cell top) to allow the desired flow rate. A 250-ml graduate and timer was used in this testing to set 500-mls/min. flow.
11. Re-adjust the pressure as needed. Changing the concentrate flow will change the system pressure and vise-versa.
12. Allow the system to run for 60 minutes prior to recording any data. Check the system pressure over the next few hours to make certain it remains constant. Adjust as needed.
   Data Collection
1. Verify the concentrate flow rates and system pressure about 60 minutes prior to taking any readings.
2. Record the tank temperature, pH, and conductivity/TDS. If the pH is to be adjusted do this after all readings are taken.
3. Measure the flow rates for both permeate lines. This is best done with a 10-ml graduate and a timer.
4. Collect the permeates from each test cell individually into a beaker and check their conductivity/TDS.
5. Measure the conductivity/TDS for both the concentrates.
6. Analyze for any other parameters to be tracked in the feed tank, e.g. ClO₂, NaOCl, and NaClO₂.
7. After 120 hours of operation, or whatever time period is appropriate, take the final data set and turn off the system pump.
8. Two independent variables, Coefficients A and B, were calculated using the collected data in order to measure the performance of the membranes without the influence of variations in flow and pressure.
   Coef. A=(100,000)(perm flow rate/3785.4)/(Pnet)/(memb. Sq. ft.)
   Coef B=((perm TDS)(perm flow)/1000/60))/((memb. Sq. ft.*Beta*0.5)(feed TDS+conc TDS−perm TDS))*28316/1000
   P(net)=(((feed pres+conc pres)/2)−perm pres)−((Beta*(feed osm pres+conc osm pres)/2)−perm osm pres)
   Osmotic Pressure for Permeate=perm TDS/112 TDS/psi (this is the same for the other flows by substituting the appropriate TDS)
   Beta=EXP((0.7)*(perm flow rate)/(0.5*(feed flow rate+conc. Flow rate)))
      Beta value or concentration polarization by definition is the amount (B) times the feed concentration average that estimates the actual average concentration at the membrane surface as part of the boundary layer theory.
         Bacteria Plating Procedure
         The amount of biofilm that developed on the membrane surface was determined by the following procedure. Samples from the surface of each membrane were collected at the end of each test run using the procedure described below.
1. Place a sterile template with a 1-cm circular hole on top of the membrane taken directly from the cell. The template can be sterilized in isopropanol or equivalent. Do not rinse the membrane before plating.
2 Use a 3-M Quick Swab to clean the area inside the template.
3. Transfer the sample back into the Quick Swab tube and mix.
4. Pour the contents (1-ml) of the Quick Swab into a serial dilution vial (containing 9-mls water) and shake. Rinse the solutions back-and-forth at least 3 times.
5. Remove 1-ml from the first dilution vial and place onto a 3-M PetriFilm. Follow the PetriFilm directions (lift film cover, inject 1-ml sample, drop cover, and press with template).
6. Transfer 1-ml from vial 1 to a second vial and repeat the plating for 5 dilutions. Each dilution vial is a factor of 10 from the previous. The first vial is a 1×10¹ dilution. The 1-ml of solution from a Quick Swab can be plated to check for bacteria without dilution.
7. Do the PetriFilm plates in triplicate and place them in an oven set at 35° C. over night.
8. After development read the plates by counting either all of the bacteria colonies (red dots) over the entire 20 cm² area from the PetriFilm template or count the colonies in one square of the plate and multiply by 20, as for example: (27 bacteria colonies per cm²)×(20 cm²)×(10³)=540,000 colony forming units (CFUs)

The inventors envision employing their invention as described herein and as set forth in the examples which follow.

### EXAMPLES

### Example 1

### Baseline Run with No Biocide in Tap Water

The system was sterilized using the procedure described above. DowFilmtec, FT-30 membranes were placed in the membrane holders. Next, approximately 80 Liters of dechlorinated tap water were added to the feed tank. Sodium chloride was added to give a concentration of 1000-ppm. The total dissolved solids (TDS) were measured at 2190-ppm. The system was operated for 191 hours. At the end of the run, the membrane's surfaces were sampled using the Bacteria Plating procedure described above. The average CFU count was 260,000.

### Example 2

### Baseline Run with No Biocide in Deionized Water

The system was sterilized using the procedure described above. DowFilmtec, FT-30 membranes were placed in the membrane holders. Next, approximately 80 liters of deionized water were added to the feed tank. Sodium chloride was added to give a concentration of 1000-ppm. The total dissolved solids (TDS) were measured at 1310-ppm. The system was operated for 122 hours. At the end of the run, the membrane's surfaces were sampled using the Bacteria Plating procedure described above. The average CFU count was 3,250,000

### Example 3

### Deionized Water with 1.0-Parts Per Million Chlorine Dioxide

The system was sterilized using the procedure described above. DowFilmtec, FT-30 membranes were placed in the membrane holders. Next, approximately 80 liters of deionized water were added to the feed tank. Sodium chloride was added to give a concentration of 1000-ppm. The total dissolved solids (TDS) was measured at 1430-ppm. The system was operated for about 100 hours at, which time the pump failed. At the end of the run, the membranes surfaces were sampled using the Bacteria Plating procedure described above. The average CFU count was less than 20.

### Example 4

### Deionized Water with 0.5 Parts Per Million Chlorine Dioxide

The system was sterilized using the procedure described above. DowFilmtec, FT-30 membranes were placed in the membrane holders. Next, approximately 80 liters of deionized water were added to the feed tank. Sodium chloride was added to give a concentration of 1000-ppm. The total dissolved solids (TDS) was measured at 1470-ppm. The system was operated for about 240 hours. At the end of the run, the membrane's surfaces were sampled using the Bacteria Plating procedure described above. The average CFU count was zero.

### Example 5

### Deionized Water with 0.1 Parts Per Million Chlorine Dioxide

The system was sterilized using the procedure described above. DowFilmtec, FT-30 membranes were placed in the membrane holders. Next, approximately 80 liters of deionized water were added to the feed tank. Sodium chloride was added to give a concentration of 1000-ppm. The total dissolved solids (TDS) was measured at 1350-ppm. The system was operated for about 149 hours using a ClO₂ concentration of 0.3-ppm. The ClO₂ concentration was allowed to drop until reaching an average concentration of 75-ppb at which it was maintained to the end of the run at 240 hours. At the end of the run, the membrane's surfaces were sampled using the Bacteria Plating procedure described above. The average CFU count was zero.

### Example 6

### Deionized Water with 0.01 Parts Per Million Chlorine Dioxide

The system was sterilized using the procedure described above. DowFilmtec, FT-30 membranes were placed in the membrane holders. Next, approximately 80 liters of deionized water were added to the feed tank. Sodium chloride was added to give a concentration of 1000-ppm. The total dissolved solids (TDS) was measured at 1300-ppm. The system was operated for about 120 hours using a ClO₂ concentration of 0.05-ppm. The ClO₂ concentration was allowed to drop until reaching an average concentration of 10-ppb at which it was maintained to the end of the run at 120 hours. At the end of the run, the membrane's surfaces were sampled using the Bacteria Plating procedure described above. The membranes were visually inspected and found to be free of biological slime.

### Example 7

### Treating RO Feed Water with Chlorine Dioxide from Ultraviolet Light Activation of Sodium Chlorite

The RO test system was modified to operate as a once through system. A large batch tank was added which contained 1000-ppm sodium chloride in deionized water to serve as feed water to the RO system. A pump for dosing sodium chlorite solution to the feed water was added. The feed water containing the sodium chlorite was passed over an ultraviolet light source. The ultraviolet energy converted a portion of the sodium chlorite to chlorine dioxide. At a feed water sodium chlorite concentration of about 1000-ppb, approximately 15-ppb chlorine dioxide was formed. The feed water containing the chlorine dioxide was feed to the flat plate cells containing the TFC (Thin Film Composite) membranes. After 120 hours of operation the membranes surfaces were sampled using the Bacteria Plating procedure described above. The membranes were visually inspected and found to be free of biological slime.

### Example 8

### Treating RO Feed Water with Chlorine Dioxide from Acid Activation of Sodium Chlorite

The RO test system was modified to operate at a once through system. A large batch tank was added which contained 1000-ppm sodium chloride in deionized water to serve as feed water to the RO system. A pump for dosing sodium chlorite solution to the feed water was added. A second pump was added for dosing acid into the feed water to produce a pH of 3.5. An expansion tank was added to increase the contact time between the sodium chloride and acid prior to entering the flat plate cells containing the TFC membranes. The feed water exiting the expansion tank had a chlorine dioxide concentration of 15-ppb. The feed water containing the chlorine dioxide was feed to the flat plate cells containing the TFC membranes. After 120 hours of operation the membranes surfaces were sampled using the Bacteria Plating procedure described above. The membranes were visually inspected and found to be free of biological slime

### Example 9

### Treating RO Feed Water and Membranes with Chlorine Dioxide from a Complex of Sodium Chlorite and Chlorine Dioxide

The RO test system was modified to operate at a once through system. A large batch tank was added which contained 1000-ppm sodium chloride in deionized water to serve as feed water to the RO system. A pump for dosing a solution containing a complex of sodium chlorite and chlorine dioxide solution to the feed water was added. The feed water to which the sodium chlorite/chlorine dioxide complex had been added was feed to the flat plate cells containing the TFC membranes. At a feed water sodium chlorite concentration of about 10000-ppb, approximately 15-ppb chlorine dioxide was formed. The feed water containing the chlorine dioxide was feed to the flat plate cells containing the TFC membranes. After 120 hours of operation the membranes surfaces were sampled using the Bacteria Plating procedure described above. The membranes were visually inspected and found to be free of biological slime.

### Example 10

### Treating RO Feed Water and Membranes with Chlorine Dioxide Using an Electrochemical Generator for Production of Chlorine Dioxide

The RO test system was modified to operate at a once through system. An electrochemical generator which converts chlorite ion into chlorine dioxide was connected via a feed pump to the RO system in order to meter chlorine dioxide into the feed water. A large batch tank was added which contained 1000-ppm sodium chloride in deionized water to serve as feed water to the RO system. The feed water to which the chlorine dioxide from the electrochemical generator had been added was feed to the flat plate cells containing the TFC membranes. The amount of chlorine dioxide being feed was monitored and controlled using a potentiostatic probe connected to a microprocessor controller. After 120 hours of operation the membranes surfaces were sampled using the Bacteria Plating procedure described above. The membranes were visually inspected and found to be free of biological slime.

Obviously, many modifications may be made without departing from the basic spirit of the present invention. Accordingly, it will be appreciated by those skilled in the art that within the scope of the appended claims, the invention may be practiced other than has been specifically described herein.

1. A method for treating a membrane separation system to control the formation of biofilm comprising dosing the feed water of said system with subparts per million level of chlorine dioxide.

2. A method for treating a membrane separation system comprising treating the membrane separation system on a continuous or intermittent basis using a chlorine dioxide substantially at a concentration of 1-900 parts per billion to prevent or control the formation of biofilm.

3. The method of claim 2 wherein the chlorine dioxide concentration is 1 to 500 parts per billion.

4. The method of claim 3 wherein the concentration is substantially 1 to 100 parts per billion in the feed water.

5. The method of claim 2 wherein the process is carried out between a pH of 2 to 10.

6. The method of claim 2 wherein the chlorine dioxide level is controlled by a potentistatic analyzer.

7. The method of claim 2 wherein only the membranes in the membrane separation system are treated by applying the chlorine dioxide at a position proximate to the membrane.

8. The method of claim 2 wherein the process is carried out by dosing the feed water with chlorine dioxide.

9. A method for treating a membrane separation system to control the formation of biofilm comprising treating the membrane system with chlorine dioxide at a concentration of 500 parts per billion or less to prevent or control the formation of biofilm.

10. The method of claim 2 wherein the chlorine dioxide is produced by employing ultraviolet light to convert a chlorite salt to chlorine dioxide.

11. The method of claim 10 wherein the chlorite salt is sodium chlorite.

12. The method of claim 2 wherein the chlorine dioxide is produced by lowering the pH to an acid pH to convert chlorite to chlorine dioxide.

13. The method of claim 2 wherein the chlorine dioxide is produced employing a complex of sodium chlorite and chlorine dioxide.

14. A membrane separation system for preventing membrane fouling comprising 1) a source of chlorine dioxide, 2) a chlorine dioxide dosing system, 3) a potentiostatic probe for monitoring the chlorine dioxide concentration, and 4) a microprocessor interfaced with the probe such that the chlorine dioxide dosing system is able to control the chlorine dioxide concentration in the feed water at a concentration of 1 to 500 parts per billion.

15. A membrane separation system for preventing membrane fouling comprising 1) a membrane, 2) ultraviolet light, 3) chlorite ion in the feed water such that the ultraviolet light converts the chlorite ion in the feed water into chlorine dioxide at a concentration range of 1 to 900 parts per billion.

16. The membrane separation system for preventing membrane fouling of claim 14 wherein chlorine dioxide is supplied to the system employing 1) a solution of sodium chlorite, 2) a means for adding the sodium chlorite to the RO feed water, 3) means for adjusting the pH of the feed water, 4) ultra violet light, and 5) a means for measuring the concentration of chlorine dioxide with an analyzer to control the addition of sodium chlorite to the feed water to maintain a set chlorine dioxide concentration in the concentration range of 1 to 900 parts per billion.

17. A membrane separation system for preventing membrane fouling comprising a membrane and chlorite ion in the feed water along with a means for adjusting the pH so that the chlorite ion is converted into chlorine dioxide by said pH adjustment to a concentration of 1 to 900 parts per billion.

18. A membrane separation system for preventing membrane fouling wherein chlorine dioxide is supplied to the system employing components comprising 1) a solution of sodium chlorite, feed tank and pump, 2) an acid solution, feed tank and pump, 3) a pH monitor and controller which monitors the feed water or portion thereof, and a chlorine dioxide analyzer monitoring the feed water after the sodium chlorite and acid feed point(s) such that the addition of sodium chlorite and acid are controlled to give the desired concentration of chlorine dioxide in the feed water to the RO system.

19. A membrane separation system comprising 1) a membrane which is liable to be fouled and 2) a complex of sodium chlorite and chlorine dioxide as a source of chlorine dioxide for supplying chlorine dioxide at a concentration of 1 to 900 parts per billion to the membrane in the membrane separation system thereby preventing membrane fouling.

20. A membrane separation system comprising a membrane which is liable to be fouled and an electrochemical generator used to convert chlorite ion into chlorine dioxide for providing chlorine dioxide to the membrane separation system at a chlorine dioxide concentration of about 1 to 500 parts per billion.

21. A membrane separation system for preventing membrane fouling of claim 19 wherein the chlorine dioxide is supplied to the system employing components comprising 1) an electrochemical chlorine dioxide generator, 2) a feed pump for dosing chlorine dioxide to the RO feed water, 3) a means for measuring and controlling the subsequent concentration of chlorine dioxide in the feed water electrochemical generation and chlorine dioxide dosing system to operate and maintain a feed water chlorine dioxide concentration at the desired level of 1 to 900 parts per billion.

22. A membrane separation system comprising 1) a membrane which is liable to be fouled and 2) an acid plus sodium chlorite supplied to a chlorine dioxide generator for producing chlorine dioxide to treat the membrane in the membrane separation system at a chlorine dioxide concentration of 1 to 500 parts per billion.

23. A membrane separation system for preventing membrane fouling wherein chlorine dioxide is supplied to the system employing components comprising 1) a solution of chlorine dioxide, 2) a chlorine dioxide feed pump set up to deliver the chlorine dioxide solution to the RO system feed water supply, and 3) a chlorine dioxide analyzer monitoring the feed water after the chlorine dioxide feed point which controls the chlorine dioxide feed pump such that the chlorine dioxide feed concentration and/or the feed rate are adjusted to allow for steady control of the chlorine dioxide concentration in the feed water at 1 to 500 parts per billion.
